(19) United States
(12) Patent Application Publication
(10) Pub. No.: US 2012/0255312 A1
(43) Pub. Date: Oct. 11, 2012

(54) Method and System to Produce Electric Power

(75) Inventors: Suresh Kalpatu Rajaraman, Macungie, PA (US); John Frederick Cirucci, Schnecksville, PA (US); Jianguo Xu, Wrightstown, PA (US); Robert Vero, Baton Rouge, LA (US); Paul Higginbotham, Guildford (GB); Kevin Boyle Fogash, Wescosville, PA (US)

(73) Assignee: Air Products and Chemicals, Inc., Allentown, PA (US)

(21) Appl. No.: 13/242,863

(22) Filed: Sep. 23, 2011

Related U.S. Application Data
(60) Provisional application No. 61/386,766, filed on Sep. 27, 2010.

(51) Int. Cl. H02K 7/18; F25B 9/06

(52) U.S. Cl. 62/6; 290/1 R

(57) ABSTRACT

An open brayton cycle power generation system is enabled and improved by integration of an energy storage system utilizing cryogenic storage of atmospheric gas. A particular improved system is an open brayton cycle power generation system in which the heating source is Concentrating Solar Power. Multiple embodiments are described which permit various modes of operation and improved overall efficiency.

### CROSS-REFERENCE TO RELATED APPLICATIONS

This application claims the benefit of U.S. Provisional Application No. 61/386,766, filed on Sep. 27, 2010. The disclosure of the Provisional Application is hereby incorporated by reference.

The instant invention is related to the following copending and commonly assigned patent applications all of which were filed on Jun. 17, 2010: application Ser. No. 12/817,583 (Docket Number 07422 USA), application Ser. No. 12/817,627 (Docket No. 07423 USA); and application Ser. No. 12/817,664 (Docket No 07428 USA). The disclosure of the previously identified patent applications is hereby incorporated by reference.

### BACKGROUND OF THE INVENTION

The instant invention relates to generating electrical power from liquefied gas wherein solar thermal energy is employed for increasing the temperature of the liquefied gas.

Known systems can cool pressurized air obtained during off-peak electricity demand hours (off-peak hours) and vaporize the pressurized air under pressure during peak electricity demand hours (peak hours).

Japanese Patent Application, JP4-132837A, which is hereby incorporated by reference in its entirety, describes a gas turbine power generation facility comprising a gas turbine for driving a power generator, a liquefaction facility for liquefying air, a storage container for storing liquefied fluid, and a vaporization facility for vaporizing the liquefied fluid and feeding the product to a gas turbine burner. When the liquefied fluid is pumped from the storage container, it is vaporized and directed to the gas turbine burner. This facility suffers from several drawbacks. For example, liquefaction of air is carried out by using a dedicated liquefier, which can be inefficient. In addition, the vaporization of the liquefied fluid and transferring of the refrigeration can be inefficient based upon including multiple heat transfer steps.

Japanese Patent Application, JP4-127850, which is hereby incorporated by reference in its entirety, describes a liquid air storage electricity generation system that cools, liquefies, and stores air under normal pressure. The liquid air is warmed and high-pressure air is extracted as required. The high-pressure air is used to drive an electricity-generating turbine and generate electricity. This system suffers from several drawbacks. For example, although use of refrigeration in liquefied natural gas vaporization can reduce energy needs for air liquefaction, liquefied natural gas is not always available. In addition, as a combustible gas, liquefied natural gas involves safety concerns for storage and transport, and more importantly, the heat exchange of liquefied natural gas, a combustible material, with an oxidizing gas (for example, air).

Japanese Patent Application, JP4-191419, which is hereby incorporated by reference in its entirety, describes methods used to supply air at a constant specified pressure to a combustion temperature. In one method, pressure is increased to a pressure substantially higher than a specified pressure, and the pressure is reduced to a constant pressure during use. In another method, pressure is raised to a specified level using a separate water head created by sea water, river water, lake water, or the like. In the methods of the JP4-191419 patent, air is liquefied and is reduced in volume as compared with the volume existing at the atmospheric pressure. The liquid is vaporized and refrigeration is stored. The stored refrigeration can be used for the precooling of air aspirated by the air liquefied to reduce the consumption of motive power by the compressor and to reduce the rate at which electric power is consumed in the production of liquid air. This method suffers from the drawback that it does not provide an efficient process for liquefying air and vaporizing the stored liquid air.

Hitachi (Hidefumi Araki, Mitsugu Nakabaru, and Kooichi Chino, Heat Transfer—Asian Research, 31 (4), 2002), which is hereby incorporated by reference in its entirety, describes high pressure air being sent to a combustor of a gas turbine during peak hours. Such a cycle involves a precooled regenerator. Precooling may be achieved by vaporization of liquefied natural gas. In some areas, liquefied natural gas may be unavailable. In addition, as a combustible gas, liquefied natural gas involves safety concerns for storage and transport and more importantly, the heat exchange, of liquefied natural gas, a combustible material, with an oxidizing gas (for example, air). Additionally, Hitachi discusses extended cooling by including a regeneration medium such as pebbles or concrete. As such, operation of the precooled regenerator, as disclosed in Hitachi, can result in the regenerator warming up over cycles due to heat leak, heat introduced by machinery such as liquid air pumps, and the heat transfer temperature difference needed for heat transfer to take place in the regenerator and other heat exchangers if the pressure of the air being cooled is the same as or similar to that of the air being heated, so such a process is not sustainable. If the pressure of the air to be heated is much lower than that of the air being cooled, the process becomes rather inefficient.

Japanese Patent Application JP8189457A (Koichi et al), which is hereby incorporated by reference, describes an open Brayton cycle power generation system using solar thermal energy as a heat source and liquefied air as a feed fluid. The liquid air is provided from storage tank. Air is converted from liquid to warm vapor by heat exchange with air exhaust from the turbine.

What is needed is a method and system for cooling and storing an atmospheric gas during a first operational period of a process cycle and heating the atmospheric gas during a second operational period, wherein the method and system operation is sustainable, reliable, and safe. Sustainability desirably includes temperatures and pressures of streams in the system, especially those of lower temperature, at the same phase of the periodic operation being kept substantially constant after weeks or months of operation of the system. Reliability desirably includes the use of materials and equipment that are not constrained by the presence of a large quantity of another material. Safety desirably includes use of non-combustible materials in the system.

### BRIEF SUMMARY OF THE INVENTION

The instant invention solves problems with the prior art by providing a method and system to produce electric power using solar thermal energy as a heat source for increasing the temperature of liquefied gas. The instant invention also solves problems associated with the prior art by integrating air liquefaction step with air repressurizing step.

An open Brayton cycle system which uses concentrated solar power (CSP) as a heat source and atmospheric gas as a working fluid can generate useful, non-fossil-fuel electric power. A problem with the Brayton cycle CSP process is the significant parasitic power load required by the front-end compression step. This parasitic power demand is concurrent with the CSP power generation step during favorable insolation periods, which generally coincide or overlap with high power demand periods. The present invention solves problems with conventional Brayton cycle CSP processes by providing a means to shift the time period for the front-end compression energy requirement to a preferred time-of-day during low power demand and pricing.

The inventive system comprises a sub-system to produce and store a liquid from a lower pressure gas stream; a sub-system to produce a higher pressure gas from the stored liquid; and a sub-system to generate electric power by heating the higher pressure gas with an external heat source, decreasing the pressure of the gas through a device which produces shaft work, and applying that shaft work to operate an electric generator. One embodiment is the use of atmospheric gas as the feed gas.

One aspect of the present disclosure includes a regeneration method for periodic cooling, storing, and heating of atmospheric gas. The method includes compressing an atmospheric gas stream to above a predetermined pressure to form at least a supercritical atmospheric gas stream (the predetermined pressure being about the critical pressure for the atmospheric gas stream), forming at least a first stream from the supercritical atmospheric gas stream, directing the first stream to a regenerator for cooling to form at least a first cooled stream, directing the first cooled stream from the regenerator, expanding the first cooled stream to form at least a liquefied atmospheric gas stream, storing at least a portion of the liquefied atmospheric gas stream as a stored liquefied atmospheric gas, pressurizing at least a portion of the stored liquefied atmospheric gas to above a second predetermined pressure to form a pressurized liquefied atmospheric gas stream (the second predetermined pressure being about the critical pressure of the liquefied atmospheric gas), and heating at least a portion of the pressurized liquefied atmospheric gas stream in the regenerator. Refrigeration below the predetermined temperature is directly or indirectly provided from an external non-combustible source to one or more of the atmospheric gas stream, the supercritical atmospheric gas stream, the first stream, the first cooled stream, the liquefied atmospheric gas stream, and the pressurized liquefied atmospheric gas stream, the predetermined temperature being about the critical temperature of the liquefied atmospheric gas stream.

Another aspect of the present disclosure includes a system for periodic cooling, storing, and heating of an atmospheric gas (e.g., via a CSP). The system includes a compressor configured to compress an atmospheric gas stream to above a predetermined pressure to form at least a supercritical atmospheric gas stream (the predetermined pressure being about the critical pressure for the atmospheric gas stream), a regenerator configured to receive a first stream formed by the supercritical gas stream and to form a first cooled stream, a pressure reducing device configured to reduce pressure of the first cooled stream and disposed to form at least a liquefied atmospheric gas stream, a container for storing at least a portion of the liquefied atmospheric gas stream as stored liquefied atmospheric gas, a pressure raising device configured to pressurize the stored liquefied atmospheric gas to above a predetermined pressure (the predetermined pressure being about the critical pressure of the atmospheric gas), and a non-combustible external refrigeration source configured to provide refrigeration below a predetermined temperature to at least one portion of the system, the predetermined temperature being about the critical temperature of the liquefied atmospheric gas stream.

An advantage of the present disclosure includes greater control and greater efficiency of heating and cooling operations in systems for cooling and storing atmospheric gas and related systems.

Another advantage of the present disclosure includes permitting a sustainable periodic cycling using a regenerator, wherein energy losses due to heat exchange are greatly reduced.

Another advantage of the present disclosure is safety due to the use of non-combustible materials in the process.

Another advantage of the present disclosure is increased versatility due to removal of the constraint of having to integrate the system with a liquefied natural gas gasification unit.

Other features and advantages of the present invention will be apparent from the following more detailed description of the preferred embodiment, taken in conjunction with the accompanying drawings which illustrate, by way of example, the principles of the invention.

One aspect of the present disclosure includes a regeneration process for periodic cooling, storing, and heating. The process includes pressurizing an atmospheric gas stream to above a predetermined pressure to form at least a compressed atmospheric gas stream (the predetermined pressure being about 2 bara), directing the compressed atmospheric gas stream to a first regenerator for cooling to form at least a first cooled stream, directing the first cooled stream from the first regenerator, pressurizing the first cooled stream to above a second predetermined pressure to form at least a supercritical atmospheric gas stream (the second predetermined pressure being about the critical pressure of the first cooled stream), directing the supercritical atmospheric gas stream to a second regenerator to form at least a second cooled stream, directing the second cooled stream from the second regenerator, reducing the pressure of the second cooled stream to form at least a liquefied atmospheric gas stream, selectively storing the liquefied atmospheric gas stream as a stored liquefied atmospheric gas, pressurizing at least a portion of the stored liquefied atmospheric gas to above a third predetermined pressure to form at least a pressurized liquefied atmospheric gas stream (the third predetermined pressure being about the critical pressure of the stored liquefied atmospheric gas), heating the pressurized liquefied atmospheric gas stream in the second regenerator to form at least a heated stream, directing the heated stream from the second regenerator, expanding the heated stream to form at least a medium pressure atmospheric gas stream, directing the medium pressure atmospheric gas stream to the first regenerator, and heating the medium pressure atmospheric gas stream in the first regenerator.

Another aspect of the present disclosure includes a regeneration system. The regeneration system includes a first compressor for pressurizing an atmospheric gas stream to above a predetermined pressure to form at least a compressed atmospheric gas stream (the predetermined pressure being about 2 bara), a first regenerator configured for cooling the compressed atmospheric gas stream to form at least a first cooled stream, a second compressor configured for pressurizing the first cooled stream to above a second predetermined pressure to form at least a supercritical atmospheric gas stream (the second predetermined pressure being about the critical pressure of the first cooled stream), a second regenerator configured to cool the supercritical atmospheric gas stream to form at least a second cooled stream, a pressure reducing device configured for expanding the second cooled stream to form at least a liquefied atmospheric gas stream, a storage container configured for selectively storing the liquefied atmospheric gas stream as a stored liquefied atmospheric gas, a pump configured for pressurizing the stored liquefied atmospheric gas to above a third predetermined pressure to form at least a pressurized liquefied atmospheric gas stream (the third predetermined pressure being about the critical pressure of the stored liquefied atmospheric gas), and an expander configured for expanding a heated stream to form at least a medium pressure atmospheric gas stream (the heat stream being formed by heating of the second regenerator). The second regenerator is configured to heat the pressurized liquefied atmospheric gas stream to form at least the heated stream and the first regenerator is configured for heating the pressurized atmospheric gas stream.

Another aspect of the present disclosure includes a regeneration process. The process includes pressurizing an atmospheric gas stream to above a predetermined pressure to form at least a compressed atmospheric gas stream (the predetermined pressure being about 2 bara), directing the compressed atmospheric gas stream to a first regenerator for cooling to form at least a first cooled stream, directing the first cooled stream from the first regenerator, further cooling the first cooled stream directed from the first regenerator by an aftercooler to form a further cooled stream, pressurizing the first cooled stream after it is further cooled to above a second predetermined pressure to form at least a supercritical atmospheric gas stream, the second predetermined pressure being about the critical pressure of the first cooled stream, directing the supercritical atmospheric gas stream to a second regenerator to form at least a second cooled stream, directing the second cooled stream from the second regenerator, reducing the pressure of the second cooled stream to form at least a liquefied atmospheric gas stream, selectively storing the liquefied atmospheric gas stream as a stored liquefied atmospheric gas, pressurizing at least a portion of the stored liquefied atmospheric gas to above a third predetermined pressure to form at least a pressurized liquefied atmospheric gas stream (the third predetermined pressure being about the critical pressure of the stored liquefied atmospheric gas), heating the pressurized liquefied atmospheric gas stream in the second regenerator to form at least a heated stream, directing the heated stream from the second regenerator, expanding the heated stream to form at least a medium pressure atmospheric gas stream, directing the medium pressure atmospheric gas stream to the first regenerator, heating the medium pressure atmospheric gas stream in the first regenerator, further heating at least a portion of the medium pressure atmospheric gas by an external heat source (e.g., a CSP), expanding the heated medium pressure atmospheric gas to a fourth predetermined pressure to form an expanded atmospheric gas, the fourth predetermined pressure being about the atmospheric pressure of the environment.

An advantage of the present disclosure includes greater efficiency of heating and cooling operations in systems for cooling and storing atmospheric gas and related systems.

Another advantage of the present disclosure includes the use of the liquid air energy storage system regardless of whether there is an external source of heat.

Another advantage of the present disclosure includes the use of the lower cost compressors, specifically, the so-called “adiabatic compressors,” or compressors with no intercoolers for compression of air or other atmospheric gases.

Other features and advantages of the present invention will be apparent from the following more detailed description of the preferred embodiment, taken in conjunction with the accompanying drawings which illustrate, by way of example, the principles of the invention.

### BRIEF DESCRIPTION OF SEVERAL VIEWS OF THE DRAWINGS

FIG. 1 is a schematic of one aspect of the invention for producing electric power.

FIG. 2 is a schematic of another aspect of the invention that incorporates auxiliary refrigeration, regenerator and supplemental heater.

### DETAILED DESCRIPTION OF THE INVENTION

Broadly, the instant invention relates to a method and system to produce electric power. The system comprises a sub-system to produce and store a liquid from a lower pressure gas stream; a sub-system to produce a higher pressure gas from the stored liquid; and a sub-system to generate electric power by heating the higher pressure gas with an external heat source (e.g., CSP), decreasing the pressure of the gas through a device which produces shaft work, and applying that shaft work to operate an electric generator.

One embodiment comprises using atmospheric gas as the feed gas. This is a readily available gas supply, and permits the system to be operated as an open system, so that the lower pressure feed gas is atmospheric gas at atmospheric pressure and the decreased pressure gas discharge from the work-producing device is discharged to the atmosphere.

Another embodiment comprises using concentrated solar thermal energy (also known as “concentrating solar power”, or simply “CSP”) as the external heat source. While any suitable source of CSP can be employed, an example of suitable CSP comprises a circular or fan shaped array of spherical, concave mirrors which are mounted for individual rotation and track the sun to concentrate reflected solar rays onto a defined area of a tower.

Another embodiment comprises operating the system such that gas liquefaction and storage occurs during a time period, and the production of higher pressure gas, heating and power generation occurs during another time period. This permits the power-consuming liquefaction step to be operated at a time-of-day when grid power is underutilized, and the power-generating heating/pressure decrease step to be performed when grid power is in demand.

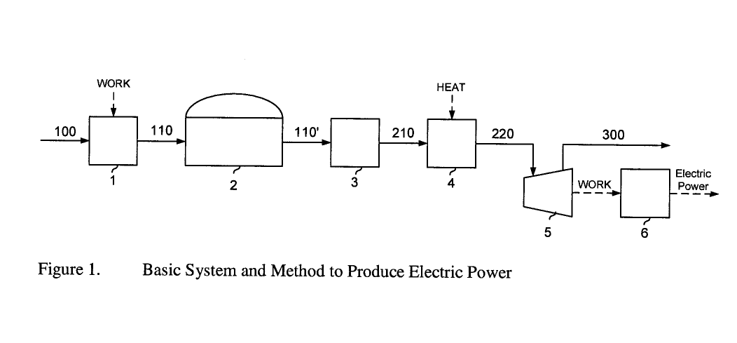

One aspect of the system and method is illustrated in FIG. 1. Referring now to FIG. 1, lower pressure gas stream, 100, which may be comprised of atmospheric gas, is a feed stream to a liquefier, 1, to produce a liquid, 110, which is stored in liquid storage container, 2. In the case of the use of atmospheric gas as the feed stream, the liquid is stored at a cryogenic temperature. After the liquid is stored for a period of time, the liquid, 110′, is removed from the liquid storage container and converted to higher pressure gas, 210, in system 3. Higher pressure gas, 210, is conducted to a heating device, 4, which may be a CSP solar collector/heat exchanger. Device 4 transfers heat into the gas stream to provide exit stream 220 at an elevated temperature. Stream 220 is conducted to a pressure reducing device, 5, such as an expander, which produces shaft work. The shaft work is applied to power generation system, 6, to produce electrical energy. Gas exiting device 5, stream 300, is now at a reduced pressure. In the case of an open system employing atmospheric gas as the feed, stream 300 is discharged to the atmosphere.

One embodiment of the system illustrated in FIG. 1 comprises liquefaction by increasing the pressure of the feed gas stream to a pressure above its critical pressure, cooling the fluid, and reducing its pressure to form liquid fluid stream, 110.

Another embodiment of the system illustrated in FIG. 1 comprises producing the higher pressure gas stream, 210, provided to the heater by removing the liquid, 110′ from liquid storage, 2, pumping the liquid to a pressure greater than its critical pressure, and heating the fluid to produce stream 210.

Another embodiment is the incorporation of a regenerator to sequentially cool and heat the fluid. The regenerator removes and stores sub-ambient heat from a fluid as part of the liquefaction step during a time period, and restores the heat to a fluid during the step of producing the higher pressure gas provided to the power generation system, during a separate time period. Various aspects and configurations of a system which cools, stores and heats an atmospheric gas are described in the previously identified copending and commonly assigned patent applications.

Another embodiment, also described in previously identified commonly assigned patent application Ser. No. 12/817,627 is the provision for supplemental cooling to be provided to the gas stream being liquefied, so that the process can be operated on a continual basis. The supplemental cooling may be provided by an auxiliary refrigeration source or may be provided by compressing, cooling, and depressurizing a portion of the feed gas, and then using this portion to remove heat from the other portion of the feed gas.

Another embodiment is the incorporation of a supplemental heating step prior to heater 4. This heating step utilizes heat from other sources, including heat of compression, or waste heat from the pressure reducing device discharge gas, or other external heat sources, or any combination. The additional heating step improves net power output relative heat input in heater 4.

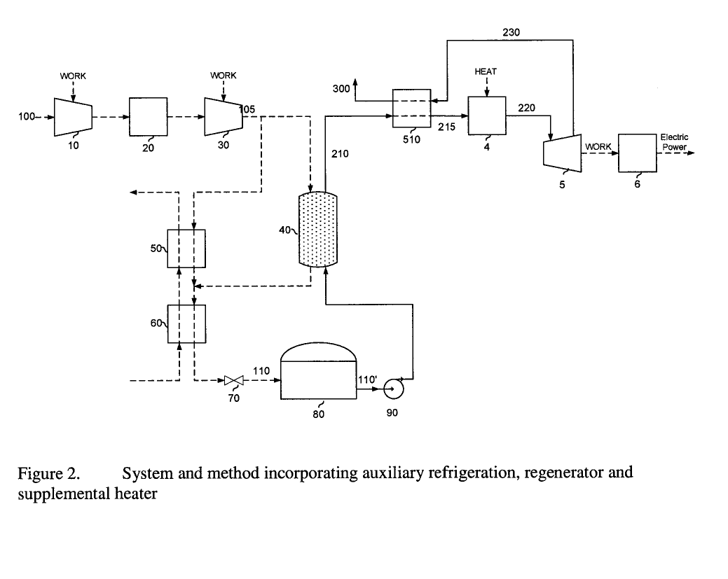

Referring now to FIG. 2, FIG. 2 depicts one embodiment which utilizes a regenerator, auxiliary refrigeration and supplemental heating. Feed gas, 100, is compressed to create in multiple stages to a pressure greater than its critical pressure in compression steps 10 and 30 to form supercritical fluid, 105. In certain case, particularly with the use of atmospheric gas as feed gas, additional purification step, 20, is provided to remove undesirable impurities. At least a major portion of fluid 105 is cooled in regenerator 40 and heat exchanger 60. Another portion of fluid 105 is cooled by heat transfer with an auxiliary refrigeration source in heat exchanger 50 and heat exchanger 60. The combined cooled stream is reduced in pressure through pressure reducing device 70, which may be a valve or may be an expander, to produce liquid stream 110. Liquid stream 110 is conducted to liquid storage container 80. After the liquid is stored for a period of time, the liquid, 110′, is removed from the liquid storage container, pumped to a pressure greater than its critical pressure and reheated in regenerator 40 to form stream 210. Stream 210 is further heated to form stream 215 in heater 510 by heat exchange with stream 300.

Stream 215 is further heated in heater 4 to form stream 220. Stream 220 is reduced in pressure in an expander or gas turbine, 5, which produces useful shaft in order to operate an electric power generator. The exhaust stream 230 from expander 5 provides heat to heater 510, and then is removed as stream 300.

An example of operating the system of FIG. 2 is a case wherein feed gas 100 is ambient air at 1 kg/s. This air is compressed in Compressors 10 and 30 to 60 bara to form supercritical fluid 105. Compressors 10 and 30 are multistage compressors with intercoolers. At an intermediate compression stage, most water and carbon dioxide are removed from the air stream in adsorber purifier 20. Approximately 1.2% of 105 is removed to heat exchanger 50 and cooled to −188 C. The combined fluids from heat exchange 50 and regenerator 40 are further cooled in heat exchanger 60 to −191 C, then expanded through dense fluid expander 70 to 1.3 bara, producing a lower pressure, liquefied fluid 110 for storage in storage container 80. At such time when it is desired to produce electric power, fluid 110 is pumped to 60 bara and heated in regenerator 40 to 100 C to form supercritical fluid 210. 210 is further heated in recuperative heater 510 to a temperature of 146.3 C. Concentrated solar energy is provided as a heat source to heater 4, increasing the temperature of exit fluid 220 to 800 C. This high temperature, high pressure supercritical fluid is reduced in pressure to near atmospheric through expander 5, which may be a multi-stage gas turbine. Expander 5 provides shaft work which drives electric generator 6 to produce electric power. The exit stream 230 from expander 5 provides heat to heater 510, and then is exhausted to atmosphere as stream 300. The energy and material balance for this example are listed in Table 1 below, and the heat exchange duties, machinery power and efficiency are listed in Table 2.

TABLE 1
Energy and Material Balance

| | Stream Number | | | | | | | |
|---|---|---|---|---|---|---|---|---|
| | 100 | 105 | 110 | 210 | 215 | 220 | 230 | 300 |
| Total Flow | 1.00 | 1.00 | 1.00 | 1.00 | 1.00 | 1.00 | 1.00 | 1.00 |
| kg/sec | | | | | | | | |
| Temperature C. | 25.0 | 107.8 | −192.0 | 100.0 | 146.3 | 800.0 | 198.1 | 150.0 |
| Pressure bar | 1.013 | 60.000 | 1.300 | 60.000 | 60.000 | 60.000 | 1.013 | 1.013 |
| Enthalpy J/kg | −269 | 75034 | −420220 | 66771 | 115907 | 836243 | 175184 | 126048 |
| Entropy J/kg-K | 160.9 | −788.4 | −3664.3 | −810.3 | −686.2 | 341.0 | 624.6 | 514.6 |

TABLE 2
Heat Exchanger Duties, Machinery Power and Efficiency

| | | |
|---|---|---|
| Heat Exchanger Duties | | |
| Compressors 10 and 30 Combined Intercooler Duty | −385 | KW |
| Heat Exchangers 50 & 60 Combined Duty | −11.6 | KW |
| Regenerator 40 Liquefaction Duty | −478 | KW |
| Regenerator 40 Vaporization Duty | 478 | KW |
| Heater 4 Concentrated Solar Energy Duty | 720 | KW |
| Machinery Power | | |
| Compression 10 & 30 Combined Power | 460 | KW |
| Pump 90 Power | 9.0 | KW |
| Expander 5 Power | −661 | KW |
| Net Power Produced (excluding refrigeration) | 192 | KW |
| Efficiency | | |

| | |
|---|---|
| Efficiency as (Expander 5 Power)/(Heater 4 Duty) | 92% |
| Efficiency as (Net Power Produced)/(Heater 4 Duty) | 27% |

It is desirable for cost optimization to have an option to provide high pressure gas to the heating/power generating system at pressure selected from a range of pressures including pressures below the gas supercritical pressure. Several embodiments of the invention include the provision to provide the gas stream, 210, to the heating device at a selected pressure below the critical pressure of the gas in order to provide an improved overall net power output relative to the net power output from the process in which supercritical gas is provided to the power generation system. The pressure is selected so that, relative to the supercritical gas case, the power requirement reduction to produce the gas feed is greater than the power generation reduction from the heater/pressure-reducer/generator. An additional consideration of pressure selection is an overall cost optimization considering both the capital cost of equipment in addition to operating efficiency. It is desirable to operate the regenerator 40 at supercritical pressure during both cooling and heating steps to avoid phase change. Therefore, several different embodiments are provided so that pressurized gas can be provided to the heating/power generation at a selected pressure below supercritical pressure.

One embodiment which provides sub-critical, pressurized gas to the heating/power generation system includes a pressure reduction step in which the pressure of the gas from regenerator is fed to pressure reducing device such as a valve.

Another embodiment which provides sub-critical, pressurized gas to the heating/power generation system includes a pressure reduction step in which the pressure of the gas from regenerator is fed to pressure reducing device which is an expander producing shaft work.

Another embodiment which provides sub-critical, pressurized gas to the heating/power generation system includes a pressure reduction step in which the pressure of the gas from regenerator is fed to pressure reducing device which is an expander producing shaft work. Further, said shaft work is applied to provide drive force to a compressor.

Another embodiment which provides sub-critical, pressurized gas to the heating/power generation system includes a pressure reduction step in which the pressure of the gas from regenerator is fed to pressure reducing device which is an expander producing shaft work. Further, said shaft work is applied to provide drive force to a compressor, in which the compressor is used to compress additional gas feed to the heating/power generating system.

Another embodiment which provides sub-critical, pressurized gas to the heating/power generation system includes a pressure reduction step in which the pressure of the gas from regenerator is fed to pressure reducing device which is an expander producing shaft work. Further, said shaft work is applied to provide drive force to a compressor, in which the compressor is used to compress gas feed, a portion of which is subsequently liquefied and conducted to the liquid storage container.

Another embodiment which provides sub-critical, pressurized gas to the heating/power generation system includes a pressure reduction step in which the pressure of the gas from regenerator is fed to pressure reducing device which is an expander producing shaft work. Further, said shaft work is applied to provide drive force to a generator system which produces electrical power.

Another embodiment which provides sub-critical, pressurized gas to the heating/power generation system includes a supplemental heating step followed by a pressure reduction step in which the pressure of the gas from regenerator is fed to pressure reducing device which is an expander producing shaft work. The supplemental heating step increases the temperature of the gas feed to the pressure reducing device such that the gas formed from pressure reducing device is discharged at a super-ambient temperature.

Another embodiment which provides sub-critical, pressurized gas to the heating/power generation system includes an additional, closed loop fluid circuit which is in communication with the regenerator. Liquid from the liquid storage container is pumped to a pressure less than its supercritical pressure and then heated by exchange with the fluid in closed-loop fluid circuit.

Another embodiment which provides additional selection of the time period for power generation is accommodation of high temperature heat storage in a portion of regenerator 40. Heat is removed from the high temperature gas exiting from heater 4 during a time period. During another time period, pressurized gas is heated by recovering heat from the high temperature portion of regenerator 40 then conducted to pressure reducing device 5. This allows the heating step performed in heater 4 and the pressure-reducing/power generation step performed in devices 5 and 6 to be operated during separate time periods. This is particularly advantageous in combination with an embodiment using a CSP heat source which is only available during daily insolation periods, which may not entirely coincide with preferred power generation periods.

The present invention is not to be limited in scope by the specific aspects or embodiments disclosed in the examples which are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

1. A system comprising a sub-system to produce and store a liquid from a lower pressure gas stream; a sub-system to produce a higher pressure gas from the stored liquid; and a sub-system to generate electric power by heating the higher pressure gas with an external heat source, decreasing the pressure of the gas through a device which produces shaft work, and applying that shaft work to operate an electric generator.

2. The system of claim 1 wherein the gas comprises atmospheric gas.

3. The system of claim 1 wherein the external heat source comprises concentrated solar power.

4. The system of claim 1 wherein the gas is provided to the external heat source at a pressure that is below supercritical pressure.

5. The system of claim 4 further comprising a pressure reducing device.

6. The system of claim 5 wherein the pressure reducing device comprises an expander producing shaft work.

7. The system of claim 6 wherein the shaft work is applied to drive a compressor.

8. The system of claim 7 wherein the compressor is used to compress gas being introduced into the system.

9. The system of claim 8 wherein the gas is liquefied and stored.

10. The system of claim 6 wherein the shaft work is applied to produce electrical power.

11. The system of claim 5 further comprising a device for increasing the temperature of the gas introduced into the pressure reducing device.

12. The system of claim 1 further comprising a closed-loop fluid circuit which is in communication with a regenerator.

13. The system of claim 12 wherein gas is heated by recovering heat from the high temperature portion of the regenerator.

14. The system of claim 12 wherein the external heat source comprises concentrated solar power.

15. A regeneration method for periodic cooling, storing, and heating of atmospheric gas, the process comprising:
compressing an atmospheric gas stream to above a predetermined pressure to form at least a supercritical atmospheric gas stream,
forming at least a first stream from the supercritical atmospheric gas stream,
directing the first stream to a regenerator for cooling to form at least a first cooled stream,
directing the first cooled stream from the regenerator,
expanding the first cooled stream to form at least a liquefied atmospheric gas stream,
storing at least a portion of the liquefied atmospheric gas stream as a stored liquefied atmospheric gas,
pressurizing at least a portion of the stored liquefied atmospheric gas to above a second predetermined pressure to form a pressurized liquefied atmospheric gas stream; and,
heating at least a portion of the pressurized liquefied atmospheric gas stream in the regenerator.

16. A regeneration process for periodic cooling, storing, and heating, the process comprising:
pressurizing an atmospheric gas stream to above a predetermined pressure to form at least a compressed atmospheric gas stream,
directing the compressed atmospheric gas stream to a first regenerator for cooling to form at least a first cooled stream,
directing the first cooled stream from the first regenerator,
pressurizing the first cooled stream to above a second predetermined pressure to form at least a supercritical atmospheric gas stream,
directing the supercritical atmospheric gas stream to a second regenerator to form at least a second cooled stream,
directing the second cooled stream from the second regenerator,
reducing the pressure of the second cooled stream to form at least a liquefied atmospheric gas stream,
selectively storing the liquefied atmospheric gas stream as a stored liquefied atmospheric gas,
pressurizing at least a portion of the stored liquefied atmospheric gas to above a third predetermined pressure to form at least a pressurized liquefied atmospheric gas stream,
heating the pressurized liquefied atmospheric gas stream in the second regenerator to form at least a heated stream,
directing the heated stream from the second regenerator,
expanding the heated stream to form at least a medium pressure atmospheric gas stream,
directing the medium pressure atmospheric gas stream to the first regenerator; and,
heating the medium pressure atmospheric gas stream in the first regenerator.

17. A regeneration process comprising:
pressurizing an atmospheric gas stream to above a predetermined pressure to form at least a compressed atmospheric gas stream,
directing the compressed atmospheric gas stream to a first regenerator for cooling to form at least a first cooled stream,
directing the first cooled stream from the first regenerator, further cooling the first cooled stream directed from the first regenerator by an aftercooler to form a further cooled stream,
pressurizing the first cooled stream after it is further cooled to above a second predetermined pressure to form at least a supercritical atmospheric gas stream, the second predetermined pressure being about the critical pressure of the first cooled stream,
directing the supercritical atmospheric gas stream to a second regenerator to form at least a second cooled stream,
directing the second cooled stream from the second regenerator,
reducing the pressure of the second cooled stream to form at least a liquefied atmospheric gas stream,
selectively storing the liquefied atmospheric gas stream as a stored liquefied atmospheric gas,
pressurizing at least a portion of the stored liquefied atmospheric gas to above a third predetermined pressure to form at least a pressurized liquefied atmospheric gas stream,
heating the pressurized liquefied atmospheric gas stream in the second regenerator to form at least a heated stream,
directing the heated stream from the second regenerator, expanding the heated stream to form at least a medium pressure atmospheric gas stream,
directing the medium pressure atmospheric gas stream to the first regenerator, heating the medium pressure atmospheric gas stream in the first regenerator, further heating at least a portion of the medium pressure atmospheric gas by an external heat source,
expanding the heated medium pressure atmospheric gas to a fourth predetermined pressure to form an expanded atmospheric gas, the fourth predetermined pressure being about the atmospheric pressure of the environment.
